(19) United States
(12) Patent Application Publication
(10) Pub. No.: US 2017/0013787 A1
(43) Pub. Date: Jan. 19, 2017

(54) Agricultural Grow Tube

(71) Applicant: Patrick Allen Diehl, Miami, FL (US)

(72) Inventor: Patrick Allen Diehl, Miami, FL (US)

(73) Assignee: Patrick Allen Diehl, Miami, FL (US)

(21) Appl. No.: 14/800,572

(22) Filed: Jul. 15, 2015

(51) Int. Cl. A01G 9/02

(52) U.S. Cl. CPC A01G 9/022

(57) ABSTRACT

The agricultural grow tube uses standard pipe and tube to except a variety of agricultural grow baskets and configurations.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of agricultural. More particularly, the present invention is in the technical field of a grow tube for plants.

Conventional agricultural grow tube are done in the extrusion process or shortly thereafter and are specifically made for there purpose. Custom applications are extremely expensive and require productions runs of 1000's of feet to be cost effective. This agricultural grow tube is unique in that it employs standard plastic pipe and tube. This agricultural grow tube has pockets embossed into it to except standard agricultural grow baskets. Furthermore this process offers flexibility to alter center to center locations of pockets as well as axial variations as per customer design specification.

### SUMMARY OF THE INVENTION

The present invention is a agricultural grow tube that employs standard plastic pipe and tube for agricultural grow basket to be inserted into.

### BRIEF DESCRIPTION OF THE DRAWING

FIG. 1 is a section view of the agricultural grow tube of the present invention;

FIG. 2 is a photograph of a prototype of the present invention;

FIG. 3 is a photograph of a typical agricultural grow basket inserted into the pocket of the present invention;

FIG. 4 is a photograph of a plant grown in the present invention;

### DETAILED DESCRIPTION OF THE INVENTION

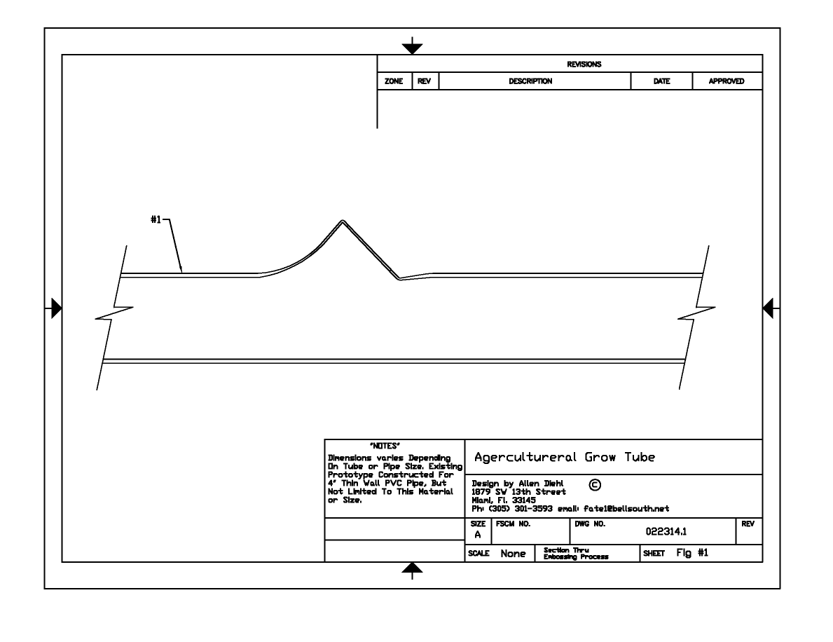

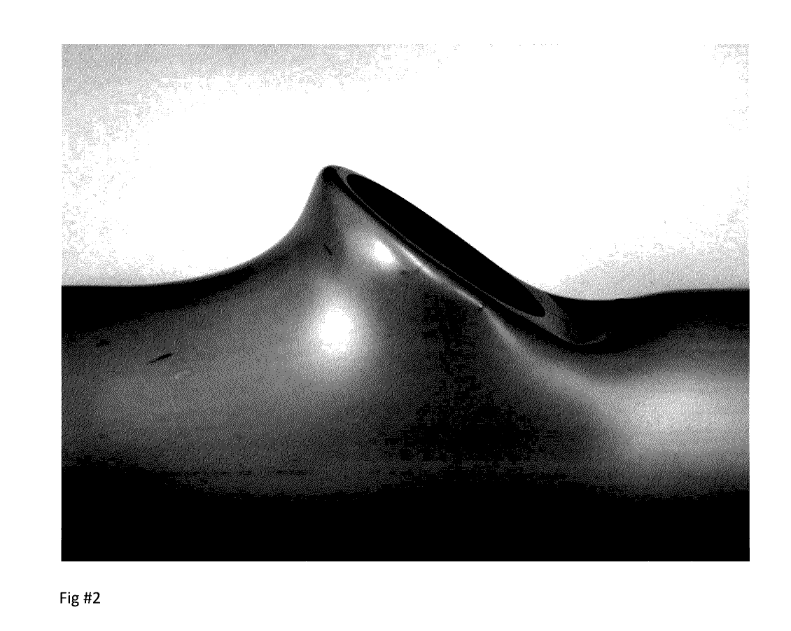

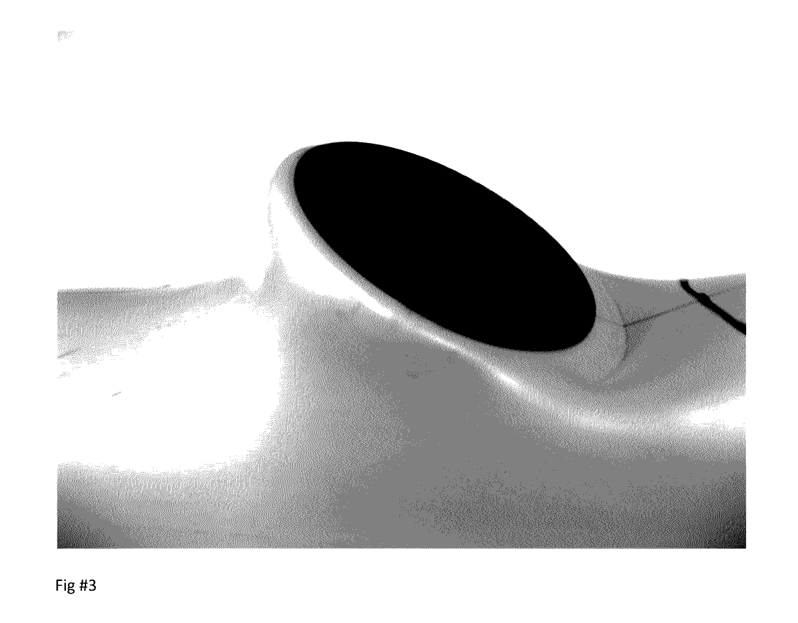

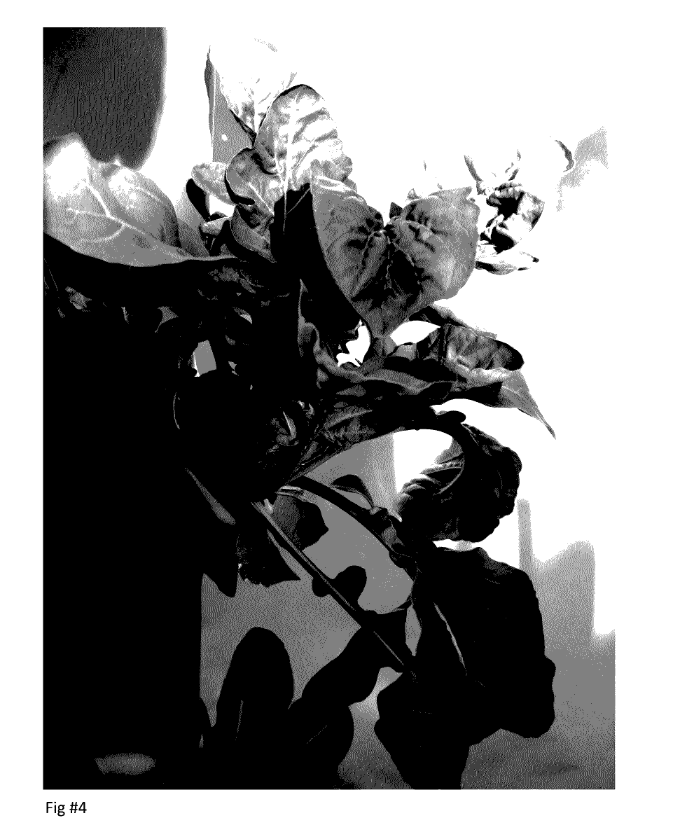

Referring now to the invention in more detail, in FIG. 1 is shown a plastic tube #1 with the pocket embossed in standard pipe or tube. In more detail, FIG. 2, shows a prototype agricultural grow tube with a pocket embossed into it. In further detail, FIG. 3, shows a standard agricultural grow basket inserted into the embossed pocket. In further detail, FIG. 4, shows a plant grown in the present invention.

The construction details of the invention as shown in FIG. 1 is that the agricultural grow tube is embossed in sufficiently rigid and strong material such as thermal plastic and the like.

The advantages of the present invention include, without limitation, that it is unique and customizable way embossed pockets in plastic pipe and tube accept a variety of agricultural grow baskets sizes and orientations. It is a cost effective method of embossed standard plastic pipe and tube without special productions runs of this material.

In broad embodiment, the present invention is a agricultural grow tube.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A agricultural grow tube formed from standard ASTM pipe and tube, comprising:
(1) a extruded pipe or tube with opening to allow agricultural grow baskets to be inserted into.
